(19) United States
(12) Patent Application Publication
(10) Pub. No.: US 2023/0112711 A1
(43) Pub. Date: Apr. 13, 2023

(54) Variable Power Microwave Cured Polyimide, Polyimide Copolymers and Nanocomposites

(71) Applicant: University of Cincinnati, Cincinnati, OH (US)

(72) Inventors: Jude Onwuegbu Iroh, Mason, OH (US); Shengdong Xiao, Crittenden, KY (US); Ruchinda Seth Gooneratne, Cincinnati, OH (US); Xuemei Cui, Cincinnati, OH (US)

(73) Assignee: University of Cincinnati, Cincinnati, OH (US)

(21) Appl. No.: 17/945,420

(22) Filed: Sep. 15, 2022

Related U.S. Application Data
(60) Provisional application No. 63/244,559, filed on Sep. 15, 2021.

(51) Int. Cl. C08G 73/10; C08K 3/04

(52) U.S. Cl. CPC C08G 73/1025; C08K 3/041; C08K 2201/005; C08K 2201/011

(57) ABSTRACT

A method of curing polyimide, polyimide copolymers, polyimide composites or combinations is provided. The method involves preparing a reaction system comprising poly(amic acid) and at least one other compound selected from the group consisting of copolymers, solvents, fillers and nanofillers. Then, a combined overall microwave absorptivity of the reaction system is determined. A temperature ramp rate is calculated for a microwave power level and time using the combined overall microwave absorptivity. The reaction system is then exposed to microwave radiation according to the calculated temperature ramp rate, producing a cured product.

### CROSS REFERENCE TO RELATED APPLICATIONS

This application claims priority to U.S. Provisional Application Ser. No. 63/244,559, filed Sep. 15, 2021, which application is hereby incorporated by reference in its entirety.

### STATEMENT REGARDING FEDERALLY SPONSORED RESEARCH OR DEVELOPMENT

This invention was made with government support under contract FA8649-21-P-0128 awarded by the Air Force Research Laboratory (AFRL). The government has certain rights in the invention.

### TECHNICAL FIELD

The present invention relates to microwave curing methods.

### BACKGROUND OF THE INVENTION

Microwave lies in the electromagnetic irradiation range from 0.3 to 300 GHz, while all domestic microwave ovens operate at a frequency of 2.45 GHz. This photon energy is too low to be directly absorbed and induce chemical reactions like UV-Vis irradiation does. Instead, this level of energy merely causes thermal heating. But unlike conventional thermal heating, which delivers energy through convection, conduction, and radiation of heat from material surfaces driven by thermal gradients, microwave converts energy directly from an electric field to the matter. This is accomplished via microwave molecular interaction, reorientation of dipole moments or ionic movement induced by alternating electric fields causing molecular friction and collision which is dissipated as heat eventually. This direct energy conversion allows for more rapid and uniform heating throughout the entire material volume. This drastically reduces the processing time, especially for polymers, which inherently have low thermal conductivity. Due to these advantages, microwave heating techniques have been widely exploited in the context of organic/pharmaceutical/polymer synthesis. Additionally, they have been used in the realm of nanotechnology, biomaterials, etc. Several attempts to use microwaves for curing of poly(amic acid) into polyimide have been reported, but they were either cured in high-cost variable frequency equipment or yielded a lower degree of imidization. Therefore, a need still exists for an effective method of using microwave radiation to cure poly(amic acid) into polyimide.

### SUMMARY OF THE INVENTION

In one embodiment, the present invention is a method of curing polyimide, polyimide copolymers, polyimide composites or combinations thereof. The method involves preparing a reaction system comprising poly(amic acid) and at least one other compound selected from the group consisting of copolymers, solvents, fillers and nanofillers. Then, a combined overall microwave absorptivity of the reaction system is determined. A temperature ramp rate is calculated for a microwave power level and time using the combined overall microwave absorptivity. The reaction system is then exposed to microwave radiation according to the calculated temperature ramp rate, producing a cured product.

In another embodiment, the reaction system is exposed to microwave radiation for a period of time from about 30 minutes to about 60 minutes. In one embodiment, the reaction system is exposed to microwave radiation for a period of time from about 40 minutes to about 50 minutes. In another embodiment, the reaction system is exposed to microwave radiation for about 40 minutes. In one embodiment, the reaction system is cured at a temperature ≤200° C.

In another embodiment, the microwave absorptivity determination is based on the reaction system and any substrates used to support the reaction system. In one embodiment, the microwave absorptivity of solvents is determined by their dielectric properties. In another embodiment, the reaction system comprises one or more carbonaceous fillers. In one embodiment, the reaction system comprises one or more nanofillers. In another embodiment, the nanofillers polyaniline-modified nanofillers. In one embodiment, the reaction system comprises carbon nanotubes, nanographene sheet, or combinations thereof. In another embodiment, the reaction system comprises single walled carbon nanotubes. In one embodiment, the reaction system comprises nanographene sheets. In another embodiment, the reaction system comprises N,N-dimethylformamide (DMF). In one embodiment, the reaction system comprises 1-methyl pyrrolidone (NMP). In another embodiment, the reaction system comprises embedded carbon nanotubes. In one embodiment the carbon nanotubes are used to sense the degree of cure. In one embodiment, the carbon nanotubes are used for in-situ structural health monitoring.

### BRIEF DESCRIPTION OF THE DRAWINGS

The foregoing summary, as well as the following detailed description of preferred embodiments of the application, will be better understood when read in conjunction with the appended drawings.

FIG. 1A is a graph showing the effect of increasing exposure time at different power levels on the change in temperature of 0.1 CNT PAA.

FIG. 1B is a graph showing the effect of increasing exposure time at different power levels on the change in temperature of 0.1 GR PAA.

FIG. 2A is a graph showing a comparison of curing temperatures achieved for PAA/carbon nanocomposites cured at respective microwave procedures.

FIG. 2B is a graph showing a comparison of curing temperatures achieved for copolyimide cured at respective microwave procedures.

FIG. 3A is a graph showing TGA of microwave cured CNT-PAA.

FIG. 3B is a graph showing TGA of oven cured CNT-PAA.

FIG. 3C is a graph showing a comparison of DTA peak areas between 100° and 375° (imidization range) for different CNT loading of microwave cured PI-CNT samples.

FIG. 3D is a table showing a comparison of DTA peak areas between 100° and 375° (imidization range) for different CNT loading of microwave cured PI-CNT samples.

FIG. 4A is a graph showing TGA of microwaved cured GR-PAA.

FIG. 4B is a graph showing TGA of oven cured GR-PAA.

FIG. 5A is a graph showing DSC of microwave cured PI-CNT.

FIG. 5B is a graph showing DSC of oven cured PI-CNT.

FIG. 6A is a graph showing DSC of microwave cured PI-GR.

FIG. 6B is a graph showing DSC of oven cured PI-GR.

FIG. 6C is a table showing a comparison of glass transition (Tg) temperatures for oven and microwave cured PAA Nanocomposites and co-polymers.

FIG. 7 is a graph showing FTIR spectra comparison between microwave and oven cured PAA nanocomposites.

FIG. 8 is a graph showing UV-vis spectra comparison of microwave and oven cured PAA nanocomposites.

FIG. 9A is a graph showing an XRD spectra comparison of CNT loading for comparison of two curing methods.

FIG. 9B is a graph showing an XRD spectra comparison of NGS loading for comparison of two curing methods.

FIG. 10A is a graph showing stress-strain curves of microwave and oven cured 0.25 NGS-PAA composites showing respective Young's moduli.

FIG. 10B is a graph showing stress-strain curves of microwave and oven cured 0.25 CNT-PAA composites showing respective Young's moduli.

FIG. 10C is a graph showing stress-strain curves of microwave and oven cured 1.0 NGS-PAA composites showing respective Young's moduli.

FIG. 11A is a graph showing a comparison of storage moduli at 1 Hz for both microwave and oven cured Neat Pl.

FIG. 11B is a graph showing a comparison of loss moduli at 1 Hz for both microwave and oven cured Neat Pl.

FIG. 12A is a graph showing that PI with imbedded CNTs showed full cure after 30 minutes of exposure at 150° C.

FIG. 12B is a graph showing that a sample heated at 100° C. was still not fully cured after 100 minutes of exposure.

FIG. 13A is a graph showing TGA and DTA traces for cured PAA copolymer containing CNT sensors and fillers. The sample cured at 150° C. is nearly fully cured.

FIG. 13B is a graph showing TGA and DTA traces for cured PAA copolymer containing CNT sensors and fillers. The sample that is cured at 100° C. is still undergoing curing.

### DETAILED DESCRIPTION

One skilled in the art will recognize that the various embodiments may be practiced without one or more of the specific details described herein, or with other replacement and/or additional methods, materials, or components. In other instances, well-known structures, materials, or operations are not shown or described in detail herein to avoid obscuring aspects of various embodiments of the invention. Similarly, for purposes of explanation, specific numbers, materials, and configurations are set forth herein in order to provide a thorough understanding of the invention. Furthermore, it is understood that the various embodiments shown in the figures are illustrative representations and are not necessarily drawn to scale.

Reference throughout this specification to “one embodiment” or “an embodiment” means that a particular feature, structure, material, or characteristic described in connection with the embodiment is included in at least one embodiment of the invention, but does not denote that they are present in every embodiment. Thus, the appearances of the phrases “in an embodiment” or “in another embodiment” in various places throughout this specification are not necessarily referring to the same embodiment of the invention. Further, “a component” may be representative of one or more components and, thus, may be used herein to mean “at least one.”

Polyimides are engineering polymers with outstanding thermal and mechanical properties. They are utilized in a wide array of products ranging from electronic to aerospace. Due to their high Tg and their dense structure, polyimides are usually cured at high temperatures ≥300° C. Thus, polyimide parts are not usually manufactured by the traditional extrusion and injection molding processes.

To overcome these challenges, the present invention deliberately controls microwave heating procedures with steady-step power variation to cure polyimide, polyimide copolymers and their carbon nanotube/nanographene sheet (CNT/NGS) nanocomposites. Using this method, polyimide, polyimide-based copolymers, and their carbon nanocomposites of high imidization degree (85-100%) having superior thermal properties have been attained in dramatically improved curing efficiency at a remarkably reduced curing time of about 40 minutes. In one embodiment, the present invention uses variable power microwave curing at moderate to low temperatures ≤200° C.

One important strategy of the present invention that successfully produces thermal imidization using microwave heating is determining the temperature ramp rate by adjusting the microwave power level and time according to the combined overall microwave absorptivity of the reaction systems. The optimal ramp rate reaches the desired curing temperature, T_{cure} in the shortest time, in one embodiment, T_{cure}≤20≥10 minutes. The absorptivity calculations include solvents used to prepare the polymer solution, fillers, and substrates. The initial microwave output power level selection is important. Lower initial power settings result in better microwave absorptivity. The goal is to attain imidization or curing at a favorable temperature as fast as possible without damaging the macrostructure caused by abrupt solvent evaporation.

In general, dry organic substances are not microwave active, thus, heating will not occur. The dielectric heating by microwave irradiation is therefore mostly ascribed to the polarity of the solvent molecules. Since poly(amic acid) possesses strong dipole moments, which is assumed to be microwave absorptive, it can help with heating. Albeit, this is inferior to the heating effect of a solvent such as DMF. Along with the solvent evaporation and the formation of stiffer polyimide as the temperature increases, the heating effectiveness reduces correspondingly, resulting in a levelling off of the temperature of the yields. The microwave interactivities of the solvents are determined by their dielectric properties. The larger the loss tangent (tan 8), the more microwave energy is converted into heat, hence the faster the temperature ramp rate as a result. In some embodiments of the present invention, N,N-dimethylformamide (DMF) is used in the PAA solutions, which possesses a fair tan 8 value of 0.161. 1-methyl-2-pyrrolidone (NMP), with a higher tan 8 of 0.275, is a good alternative when carbonaceous fillers have not been incorporated.

Nanoscale curing kinetics are influenced by the presence of nanofillers coupling agents. In one embodiment, the nanofillers are used to reinforce a poly(amic acid) matrix and copoly(amic acid) resin, permitting full imidization after only about 55 minutes of exposure to microwave energy, unlike the conventional oven cured system which required about 20-100 hours of continuous thermal treatment in a vacuum oven at ≥250° C., to achieve the same level of cure, i.e. >20× improvement in kinetics.

In one embodiment, the present invention incorporates single walled carbon nanotube (SWCNT) as filler. This material, as well as nanographene sheets (NGS), improves processibility by reducing the curing time by absorbing microwave energy as well as providing a uniform thermal transport field. In one embodiment, in-situ condensation polymerization is used with carbonaceous fillers, which allows for proper wetting of nanofillers by the polar functional groups in PAA precursor comonomers prior to polymerization to form nanocomposites. In another embodiment, surface modification of nanofillers by oxidative polymerization of aniline to form polyaniline-modified nanofillers, PANi-modified-nanofillers, prior to in-situ polymerization with PAA precursor monomers is used.

The present invention utilizes an improved microwave heating method for thermal imidization instead of conventional heating. Due to the direct energy conversion through radiation-molecule interaction, heating is uniform in the entire material volume. This leads to dramatically decreased curing time (40 min in microwave oven compared to 10 h in conventional oven) and energy without trading-off their excellent thermal and mechanical properties.

### EXAMPLES

### Example 1—Microwave Power Effect on Temperature Increase

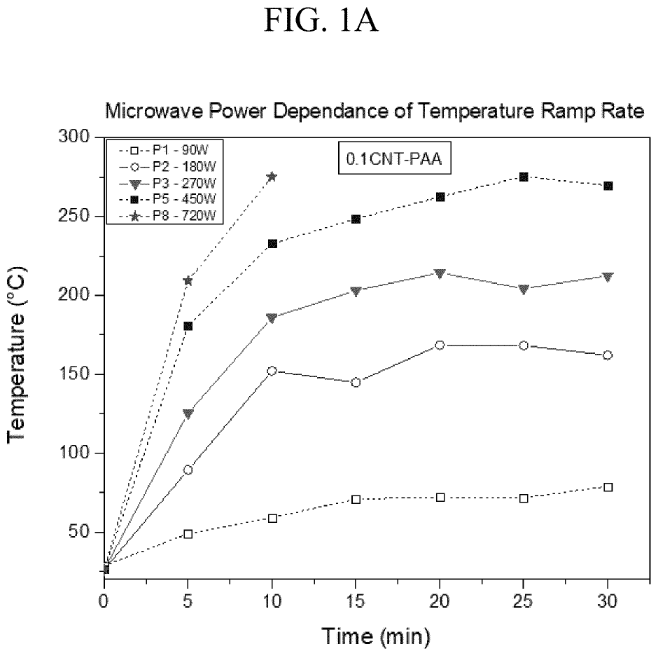

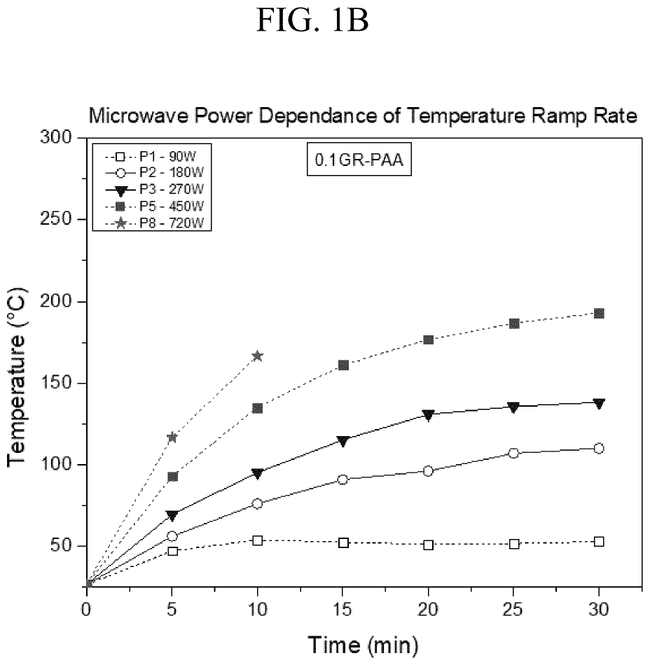

The domestic microwave oven uses fixed frequency with pulsed irradiation mode. The higher the microwave power, the longer the microwave irradiation, and therefore, the higher the temperature increase. A 0.1 wt. % CNT-PAA solution and a 0.1 wt. % NGS-PAA solution were used to demonstrate the microwave power effect on temperature increase, as shown in FIGS. 1A and 1B. The temperature ramp rate and the highest attainable temperature both increased with increasing microwave power for both composite solutions, despite the fact that CNT-PAA has a higher heating efficiency than NGS-PAA.

### Example 2—Microwave Heating Effect of Carbon Nanofillers and Copolymer Composition

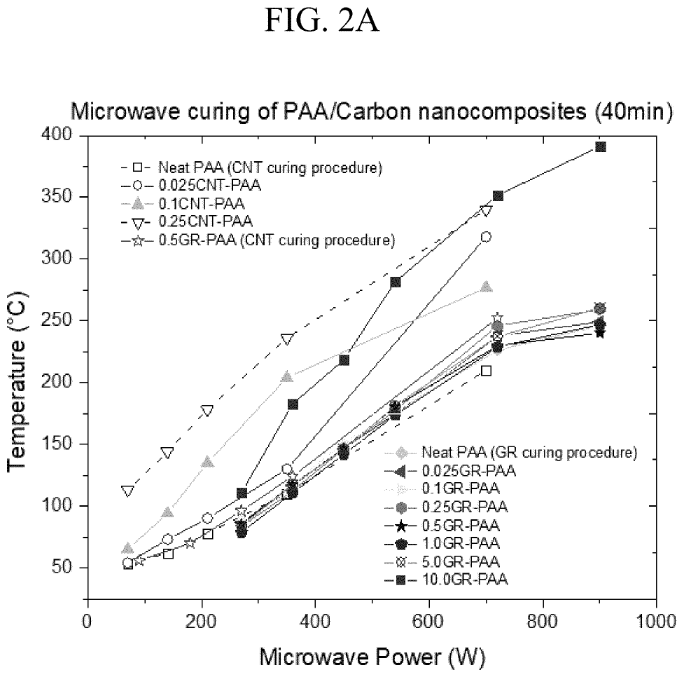

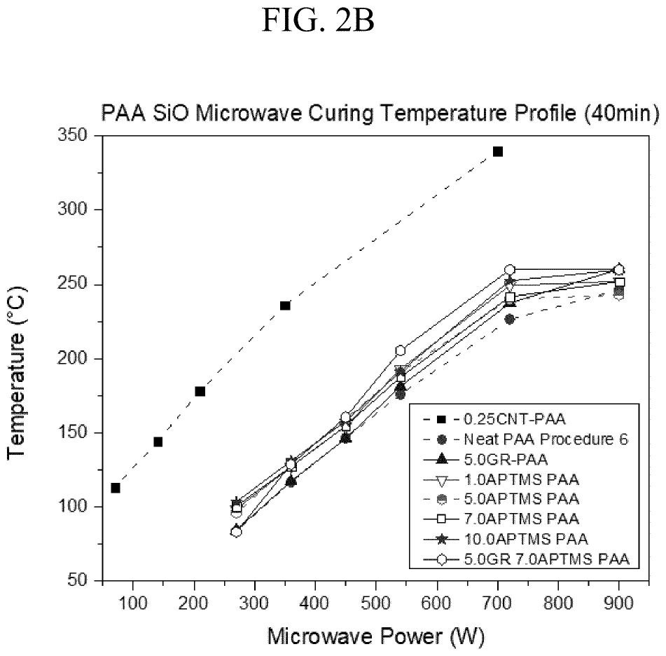

Temperature monitoring during microwave curing of PI, PI-Copolymer, PI-CNT/NGS, and Copolyimide-CNT/NGS was conducted to study the microwave heating enhancing behavior of CNT, NGS and Siloxane. As shown in FIGS. 2A and 2B, a CNT filled PAA system, even with a small loading of 0.25 wt. %, exhibited a very steep temperature ramp and attained a final temperature as high as 340° C. In contrast, NGS showed a larger percolation threshold, and a marginal heating enhancement was observed up to 5 wt. % in comparison with neat PAA. A rapid temperature ramp rate comparable with 0.25 wt. % CNT-PAA was observed for 10 wt. % NGS-PAA, with a final temperature achieved of 390° C. Both CNT and NGS composites showed an increasing heating effect with increasing filler loading. The copolyimide system did not show any improvement in microwave heating. In addition, no difference was detected with increasing copolymer content. This indicates that the copolymer is not microwave active.

### Example 3—Thermal Properties and Imidization Degree of Microwave Cured PI Systems

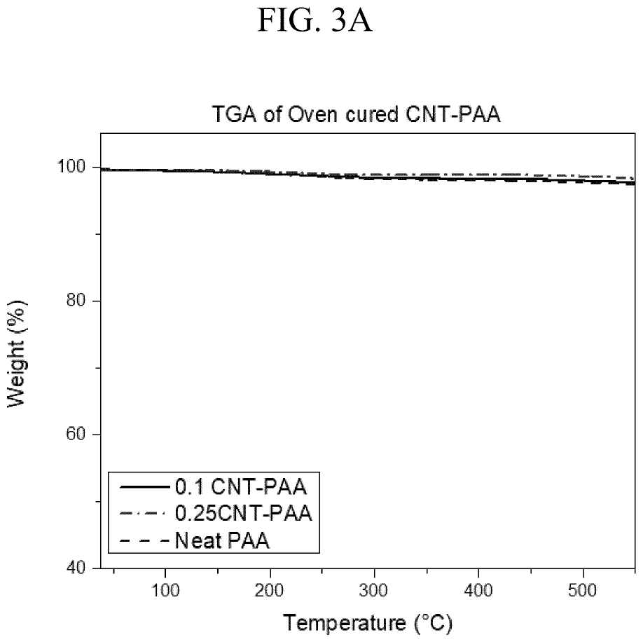

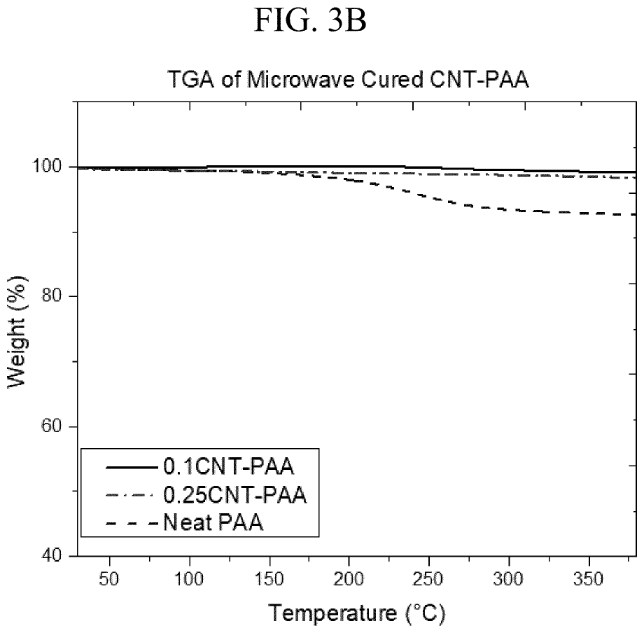

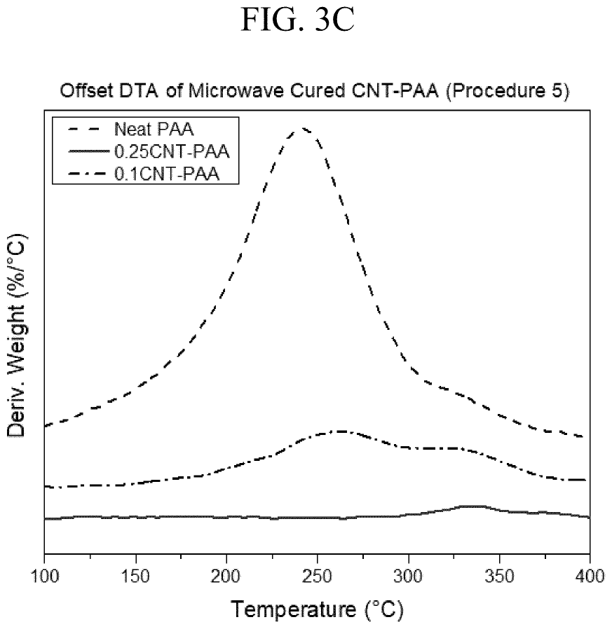

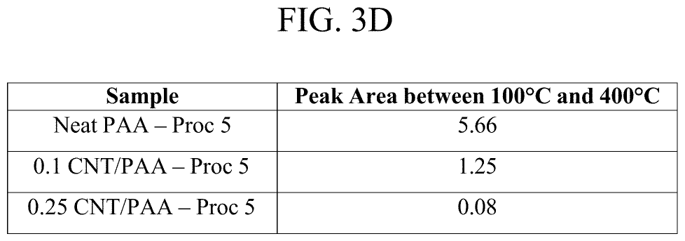

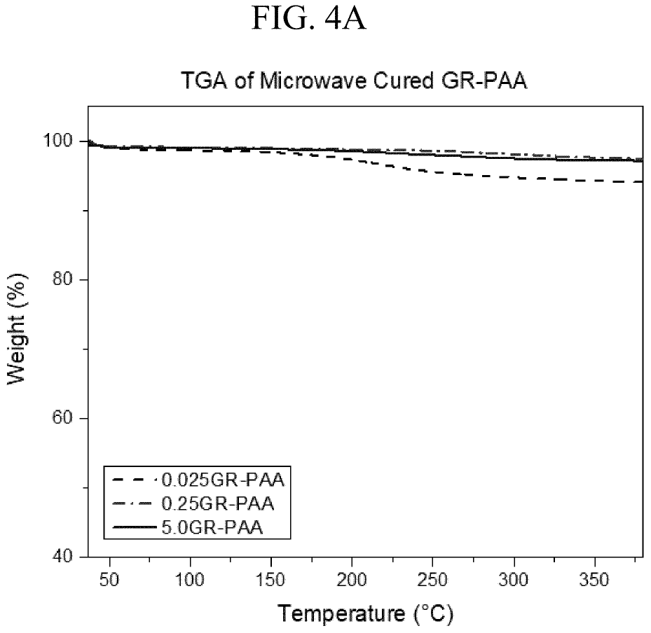

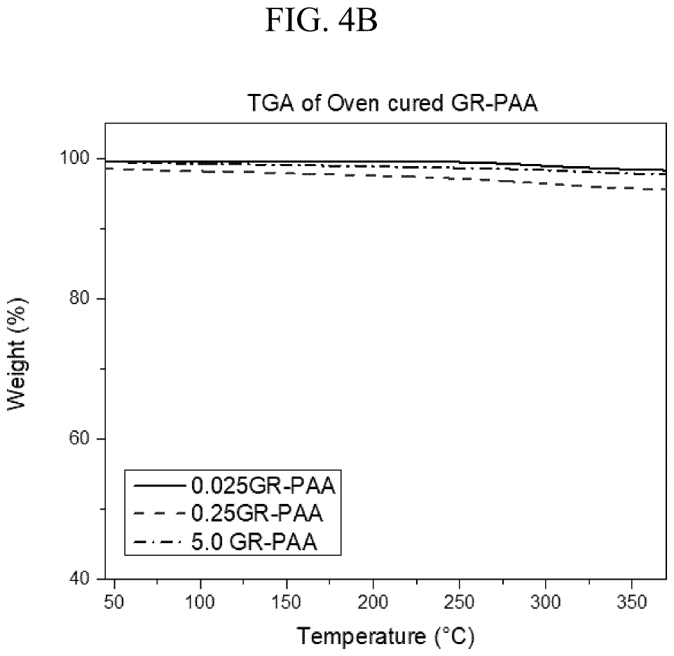

Thermogravimetric analysis (TGA) and differential scanning calorimetry (DSC) were utilized to compare thermal stabilities, glass transition temperature, Tg, and degree of imidization. FIGS. 3A and 3B show the TGA thermogram comparison of microwave (FIG. 3B) and conventional oven (FIG. 3A) cured PI-CNT composites. Imidization process took place in the temperature range between 100° C. and 375° C. Therefore, weight loss in this region of thermogram is due to the water loss from completion of the remained imidization, which can be used to calculate the degree of imidization. DTA peak areas of this temperature range can quantify the degree of imidization as well, as shown in FIG. 3C. An increasing degree of imidization was observed for increasing CNT loading for the microwave curing in FIGS. 3A-3D. No significant difference was observed for the conventional oven curing. This is because the long curing process allows for complete imidization in a conventional oven. However, both TGA curves showed a very high imidization degree (over 97%), indicating a very high curing efficiency of the microwave oven, particularly considering the significantly reduced curing time (40 minutes versus 10 hours). A similar trend in microwave cured PI-NGS was observed (see FIGS. 4A and 4B).

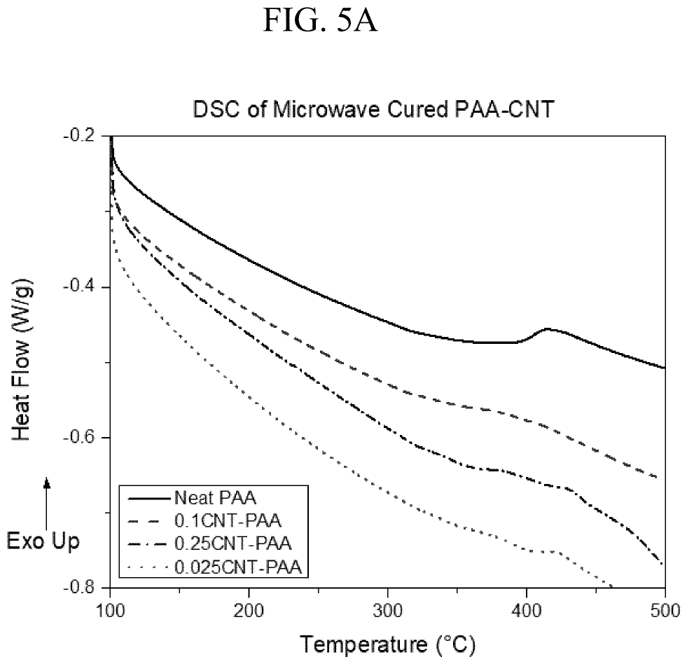

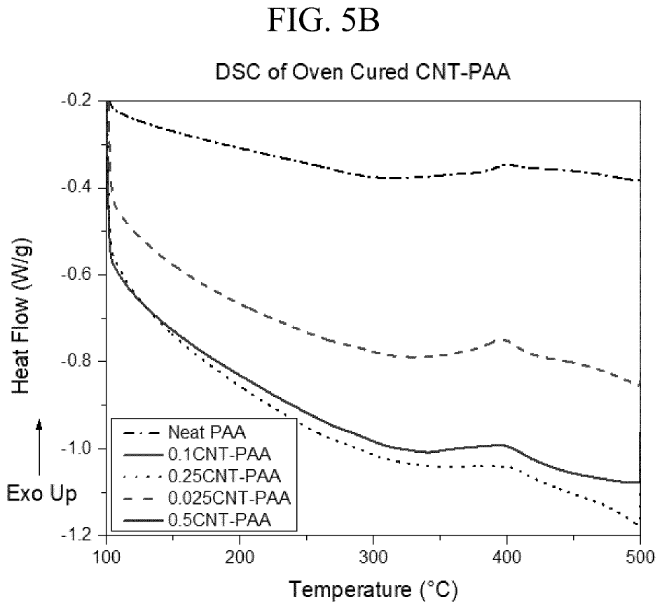

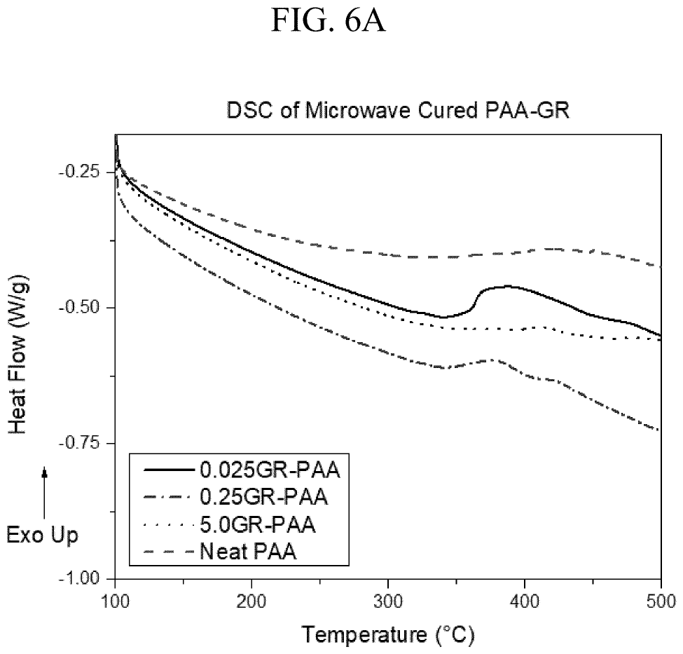

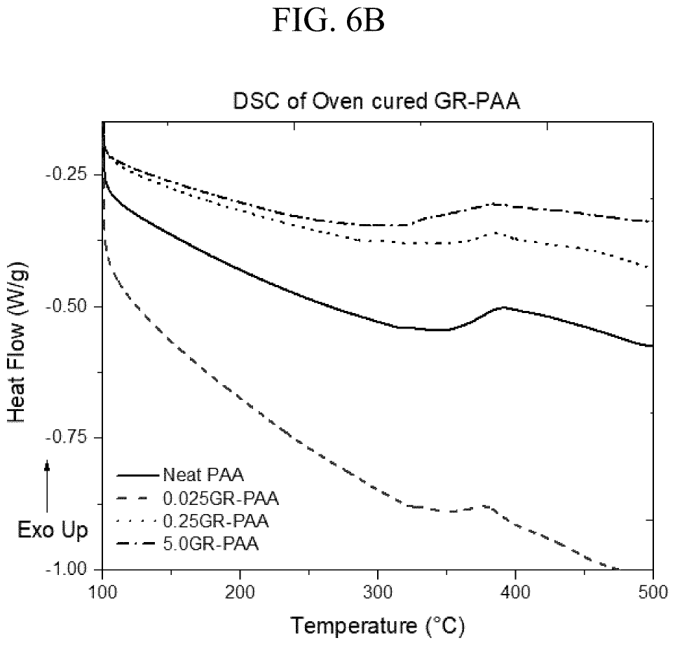

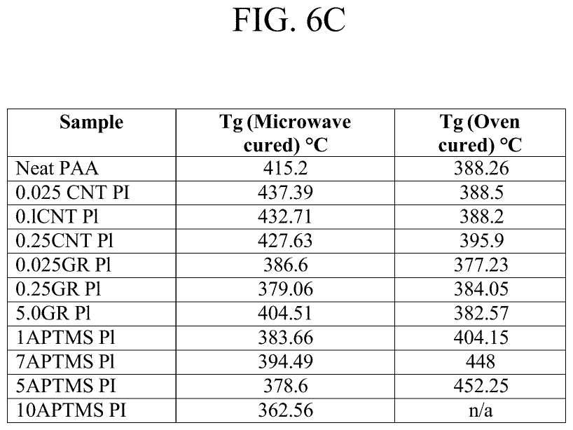

The DSC thermograms shown in FIGS. 5A and 5B indicate that the microwave cured PI-CNT has a much higher Tg when compared to the oven cured samples of the same composition. Without being bound by theory, one possible explanation is that the electromagnetic field interaction with the dipole moments causes alignment of dipoles, thus forming a more compacted polymer structure that inhibits chain mobility. Another possible explanation is that a purer imidization reaction occurred in the microwave oven without producing anhydride by-product due to the rapid curing. This may in turn cause a higher actual imidization degree. Similarly, as shown in FIGS. 6A and 6B, microwave cured PI-NGS showed a slightly higher Tg as compared to the formulation cured in the oven. Higher Tg can again be attributed to the formation of compact ordered structure of the polymer composite cured under microwave. However, the effect is much lower than PI-CNT, which can be explained as a lower imidization degree achieved in comparison to CNT due to the lower microwave absorptivity. The Tg values of selective PI-CNT/NGS and copolyimide samples cured by microwave and conventional oven are listed in the table of FIG. 6C.

### Example 4—IR and UV-Vis Spectroscopy of Microwave Cured PI Systems

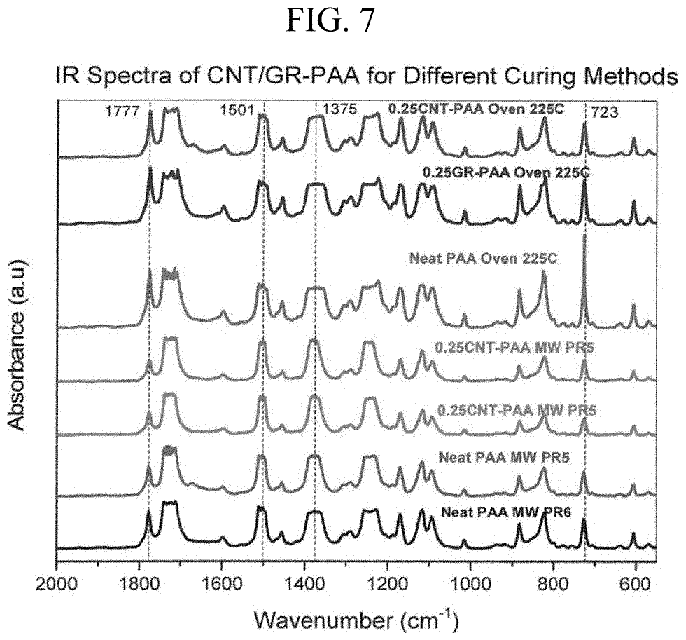

FIG. 7 shows FTIR spectra of both microwave and conventional oven cured PI-CNT/NGS composites. Characteristic imide absorption peaks at 1780 cm−1, 1380 cm−1, and 725 cm−1 indicates successful imidization for all samples. Comparatively higher intensity of conventional oven cured samples than their microwave cured counterparts was observed at 1780 cm−1 and 725 cm−1, which associates with C═O stretching and bending, respectively. Without being bound by theory, this is likely attributed to anhydride formation as a byproduct of long thermal curing cycles inherent in conventional heating. This produces a result that is consistent with the lower Tg values when compared to microwave cured samples in a DSC thermogram.

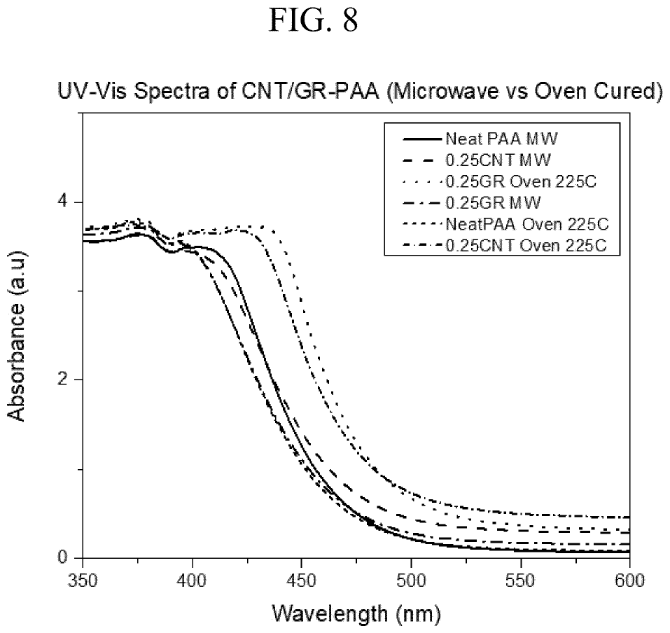

UV-Vis spectra of microwave and convention oven cured PI-CNT/NGS composites are presented in FIG. 8. The level-off absorbance increases with increasing CNT/GR loading for both curing methods as expected. Conventionally cured samples exhibit higher level-off absorbance than microwave cured for all PI-CNT/NGS. Interestingly, microwave cured samples show “blue shift” in UV-Vis wavelengths as compared to their conventionally cured counterparts for all PI-CNT/NGS composites. This phenomenon further affirms the theory regarding formation of compact, ordered and crosslinked structure induced by dipole alignment.

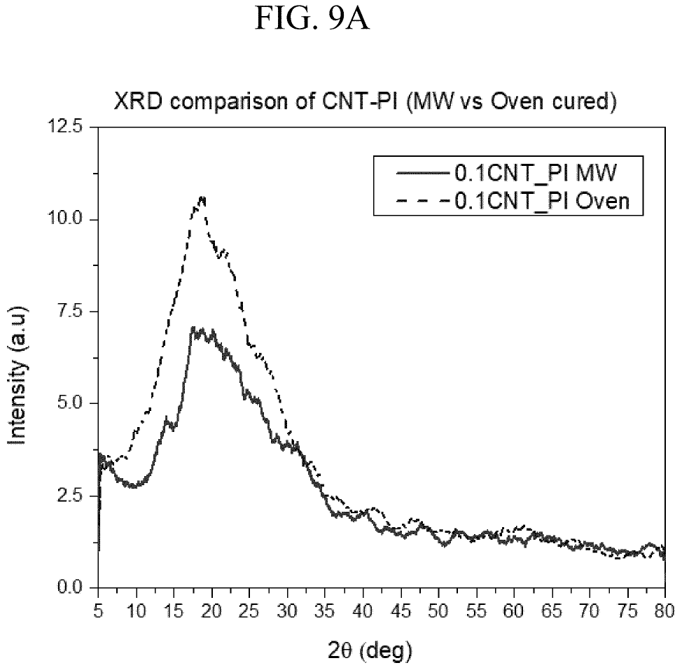

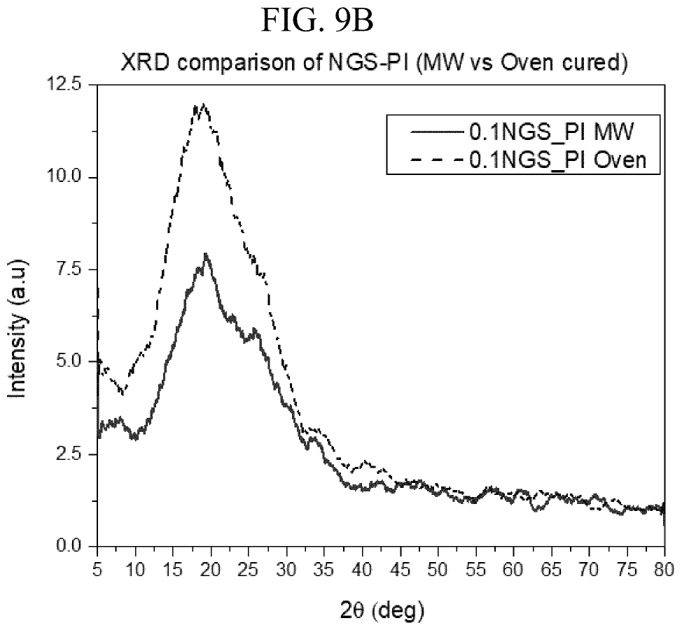

The XRD data presented in FIGS. 9A and 9B compare the effects of microwave curing with conventional oven curing between CNT/PI and NGS/PI nanocomposites. The results show relatively broad peaks between the 10° to 35° 2θ degree range of the spectrum with higher intensities observed from the oven cured samples. The nature of the peaks' breadth exhibits a more amorphous and somewhat less ordered structure. The peaks however don't show any major shift and are located at approximately the same region for both nanofiller types.

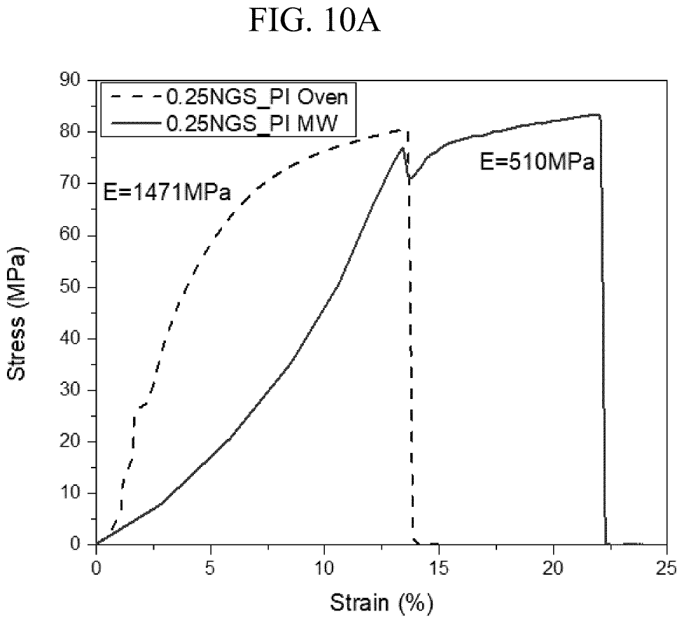

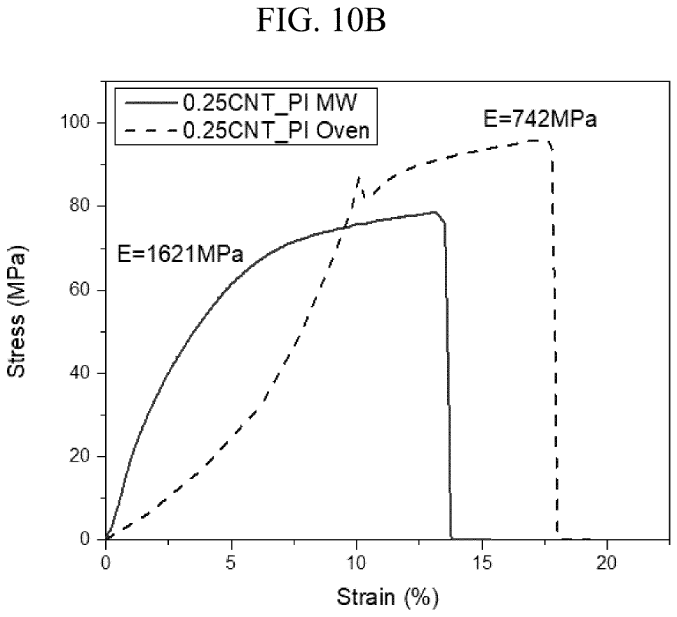

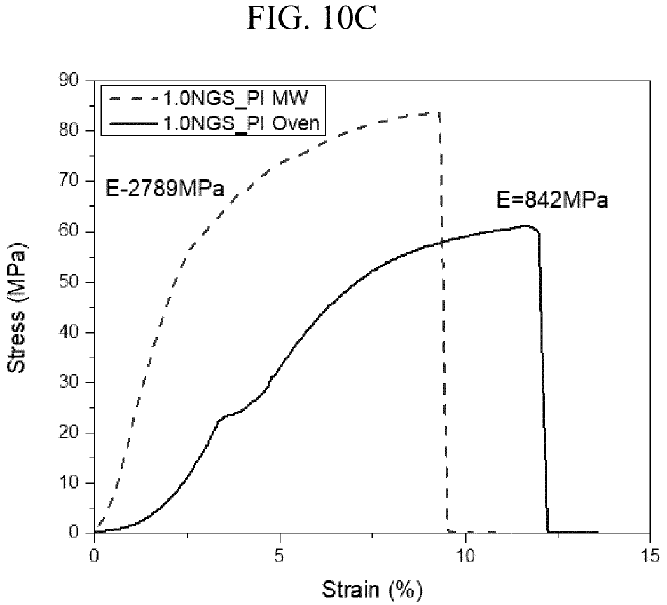

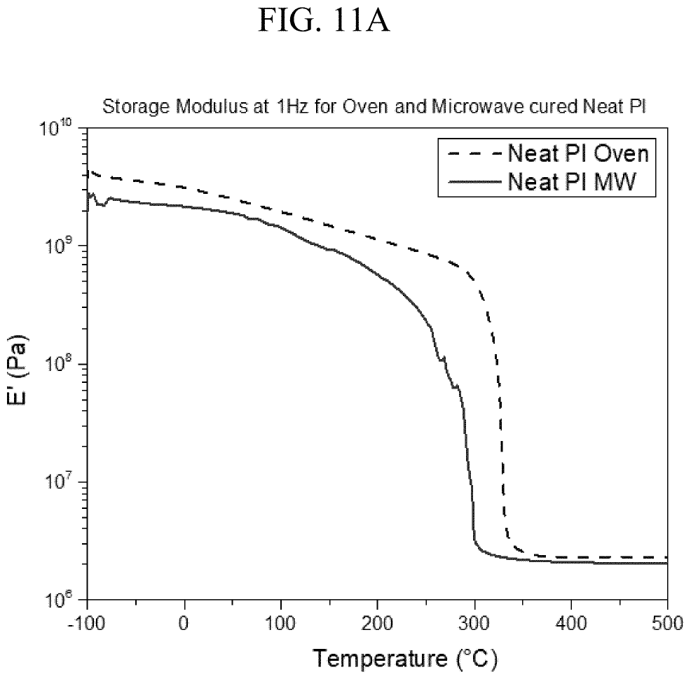

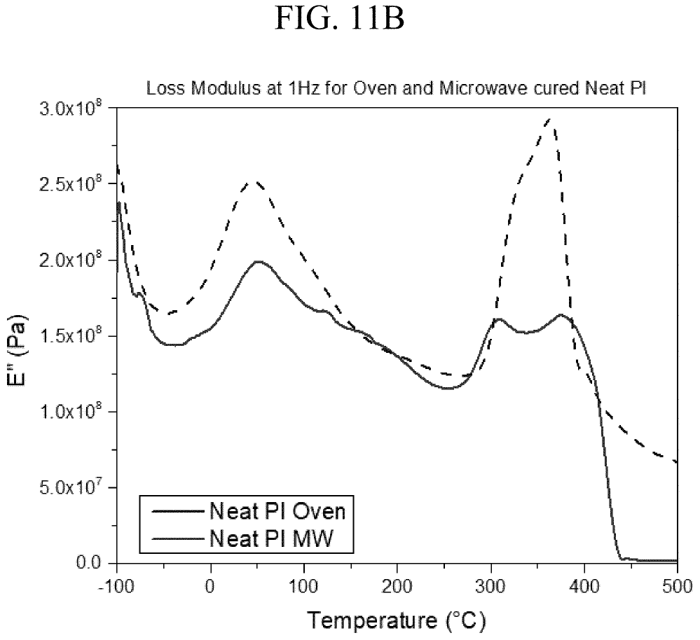

The effect of different curing methods on the mechanical properties of the PI composites were characterized using stress-strain curves using a tensile testing machine. Interestingly the Young's moduli calculated (see FIGS. 10A-10C) indicate that the microwave cured samples are on par with, and sometimes even higher than, the conventionally cured PI composites. The data indicate that microwave curing of the PI composite doesn't result in significantly different mechanical properties than PI composite cured by conventional ovens. The same analysis was true for the mechanical properties of PI nanocomposite measured using dynamic mechanical analysis (see FIGS. 11A and 11B). Both curing methods show a similar plateauing value of the storage moduli.

### Example 5—CNT as In-Situ Sensors for Curing of Thermoset Based Nanocomposites

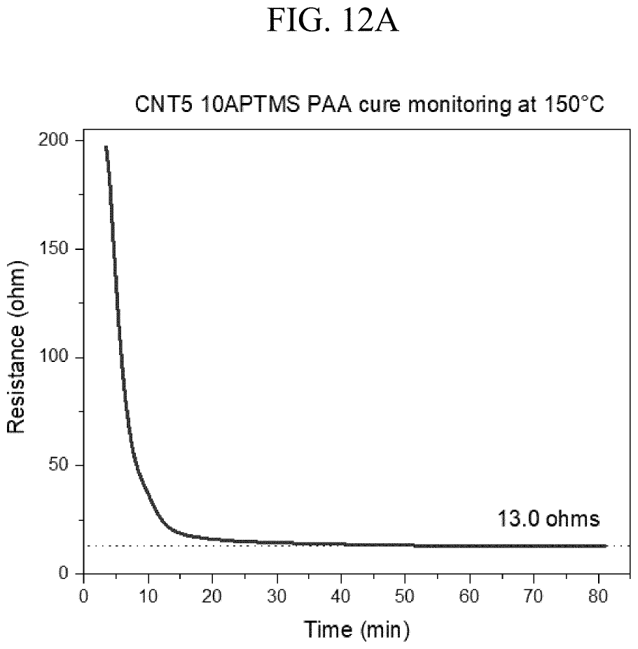

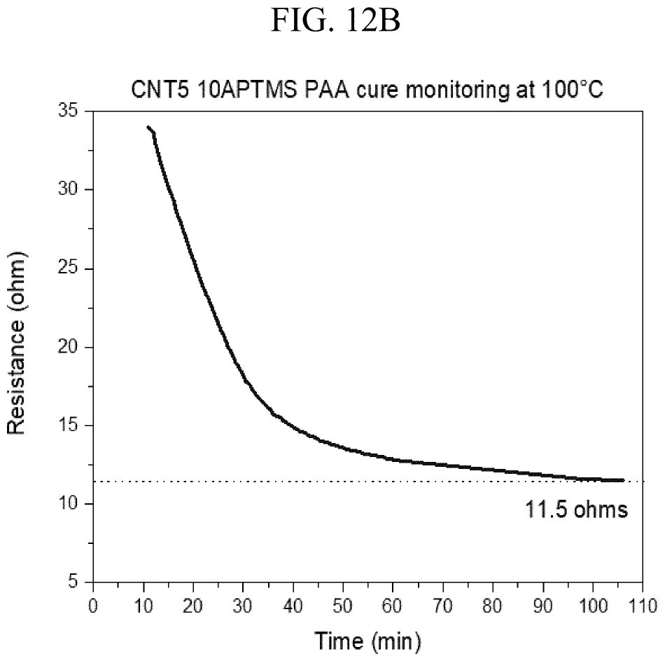

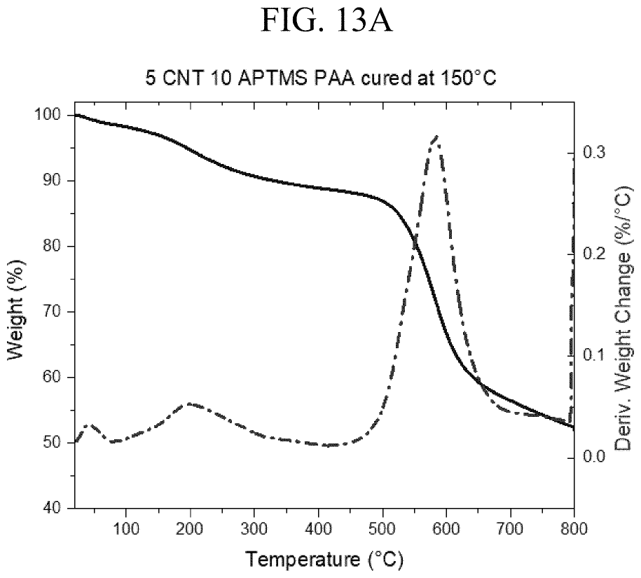

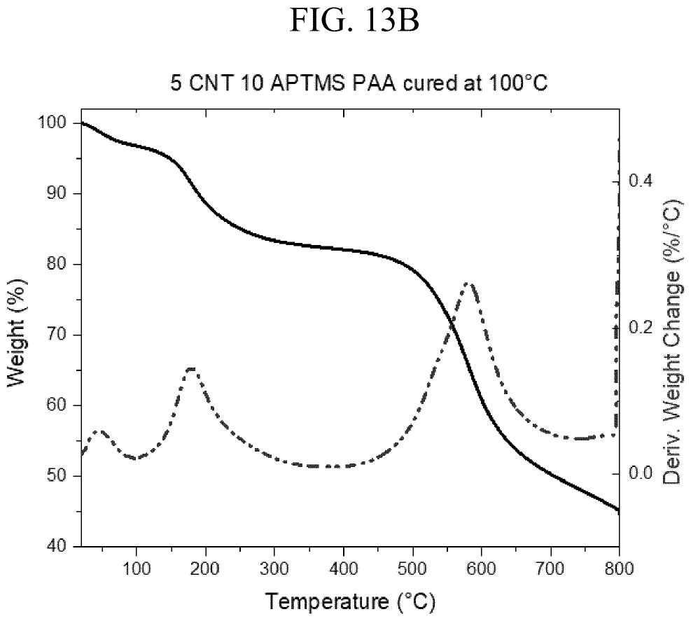

FIGS. 12A, 12B, 13A and 13B, show the cure monitoring of polyimide copolymer using imbedded CNTs. The results show that after 30 minutes of curing, full cure is achieved for samples treated at 150° C. The sample heated at 100° C. is still undergoing curing and the resistance reading has not plateaued (FIG. 12B).

The TGA of the samples cured at 100 and 150° C. show the difference between the two systems (FIGS. 13A and 13B). These figures show that embedded CNT can serve as cure sensor and can be used for in-situ structural health monitoring.

All documents cited are incorporated herein by reference; the citation of any document is not to be construed as an admission that it is prior art with respect to the present invention. It is to be further understood that where descriptions of various embodiments use the term “comprising,” and/or “including” those skilled in the art would understand that in some specific instances, an embodiment can be alternatively described using language “consisting essentially of” or “consisting of.”

While particular embodiments of the present invention have been illustrated and described, it would be obvious to one skilled in the art that various other changes and modifications can be made without departing from the spirit and scope of the invention. It is therefore intended to cover in the appended claims all such changes and modifications that are within the scope of this invention.

What is claimed is:

1. A method of curing polyimide, polyimide copolymers, polyimide composites or combinations thereof, the method comprising:
a. preparing a reaction system comprising poly(amic acid) and at least one other compound selected from the group consisting of copolymers, solvents, fillers and nanofillers;
b. determining a combined overall microwave absorptivity of the reaction system;
c. calculating a temperature ramp rate for a microwave power level and time using the combined overall microwave absorptivity; and
d. exposing the reaction system to microwave radiation according to the calculated temperature ramp rate, producing a cured product.

2. The method of claim 1 wherein the reaction system is exposed to microwave radiation for a period of time from about 30 minutes to about 60 minutes.

3. The method of claim 1 wherein the reaction system is exposed to microwave radiation for a period of time from about 40 minutes to about 50 minutes.

4. The method of claim 1 wherein the reaction system is exposed to microwave radiation for about 40 minutes.

5. The method of claim 1 wherein the reaction system is cured at a temperature ≤200° C.

6. The method of claim 1 wherein the microwave absorptivity determination is based on the reaction system and any substrates used to support the reaction system.

7. The method of claim 1 wherein the microwave absorptivity of solvents is determined by their dielectric properties.

8. The method of claim 1 wherein the reaction system comprises one or more carbonaceous fillers.

9. The method of claim 1 wherein the reaction system comprises one or more nanofillers.

10. The method of claim 9 wherein the nanofillers polyaniline-modified nanofillers.

11. The method of claim 1 wherein the reaction system comprises carbon nanotubes, nanographene sheet, or combinations thereof.

12. The method of claim 1 wherein the reaction system comprises single walled carbon nanotubes.

13. The method of claim 1 wherein the reaction system comprises nanographene sheets.

14. The method of claim 1 wherein the reaction system comprises N,N-dimethylformamide (DMF).

15. The method of claim 1 wherein the reaction system comprises 1-methyl-2-pyrrolidone (NMP).

16. The method of claim 1 wherein the reaction system comprises embedded carbon nanotubes.

17. The method of claim 16 wherein the embedded carbon nanotubes are used as a cure sensor.

18. The method of claim 16 wherein the embedded carbon nanotubes are used for in-situ structural health monitoring.
